(19) United States
(12) Patent Application Publication
(10) Pub. No.: US 2013/0090806 A1
(43) Pub. Date: Apr. 11, 2013

(54) METHOD FOR OPERATING A DRIVER ASSISTANCE SYSTEM OF A MOTOR VEHICLE AND DRIVER ASSISTANCE SYSTEM FOR A MOTOR VEHICLE

(71) Applicant: GM GLOBAL TECHNOLOGY OPERATIONS LLC, Detroit, MI (US)

(72) Inventor: Uwe Hahne, Buettelborn (DE)

(73) Assignee: GM GLOBAL TECHNOLOGY OPERATIONS LLC, Detroit, MI (US)

(21) Appl. No.: 13/645,042

(22) Filed: Oct. 4, 2012

(30) Foreign Application Priority Data
Oct. 5, 2011 (DE) 10 2011 114 888.8

(51) Int. Cl. G08G 1/16; G06F 17/00

(52) U.S. Cl. 701/36; 701/301; 701/1

(57) ABSTRACT

In one embodiment, a method for operating a driver assistance system of a vehicle is provided. The method comprises the following steps. A determination is made as to whether another road user is located in a range of a current immediate vicinity of the vehicle. If it is determined that at least one other road user is located in the range of the current immediate vicinity of the vehicle, a priority condition of the vehicle is assessed with respect to the at least one other road user. A determination is also made as to whether a possible violation of the assessed priority condition by the at least one other road user is imminent. If it is determined that a possible violation of the assessed priority condition by the at least one other road user is imminent, a signal is output automatically to the at least one other road user.

### CROSS-REFERENCE TO RELATED APPLICATION

This application claims priority to German Patent Application No. 10 2011 114 888.8, filed Oct. 5, 2011, which is incorporated herein by reference in its entirety.

### TECHNICAL FIELD

The technical field relates to a method for operating a driver assistance system of a motor vehicle, a driver assistance system for a motor vehicle, a computer software product and a computer-readable medium.

### BACKGROUND

An interactive traffic management process is known from DE 103 34 203 A1, in which the location and movement data of various road users are coordinated for the purpose of preventing accidents between these road users. In this context, in order to improve the prevention of traffic accidents in terms of both the process and a device therefor, it is suggested that at least two road users at least within an adjustable distance from one another are automatically informed about the current movement of their respective counterpart reciprocally and in direct intercommunication.

Accordingly, it is desirable to provide a method for operating a driver assistance system of a motor vehicle, a driver assistance system for a motor vehicle, a computer software product and a computer-readable medium that enable further improved avoidance of traffic accidents.

### SUMMARY

According to one aspect of the application, a method for operating a driver assistance system of a motor vehicle, wherein the driver assistance system includes a collision warning system, has the following steps. A determination is made as to whether at least one other road user is located in the range of a current immediate vicinity of the motor vehicle. If it is determined that at least one other road user is located in the range of a current immediate vicinity of the motor vehicle, a priority condition of the motor vehicle with respect to the at least one other road user is assessed. A determination is also made as to whether a violation of the determined priority condition by the at least one other road user is imminent. If it is determined that a violation of the determined priority condition by the at least one other road user is imminent, a signal is output automatically to the at least one other road user.

In this context, here and in the following the term road user is understood to mean a person or a vehicle who or that uses areas provided for use by the general public for traffic purposes, regardless of whether the person or vehicle is moving or stationary.

The method according to the embodiment described enables further improved avoidance of traffic accidents with regard to a possible collision between the motor vehicle and other road users. This is enabled by the determination of a priority condition of the motor vehicle and the assessment as to whether a possible violation of the determined priority condition by the at least one other road user is imminent, and the automatic output of a signal to the at least one other road user in the event that such a possible violation and consequently action by the other road user in contravention of traffic regulations is determined In this way, the other road user may be alerted to the possibility that a collision with the motor vehicle may be imminent and take appropriate action in good time to avoid a collision with the motor vehicle.

In one embodiment, the automatic output of a signal includes transmission of a signal via a vehicle-to-vehicle communication device. In this way, the other road user, for example a driver of another motor vehicle, may be informed directly of the possibility of an imminent collision.

In another embodiment of the method, the automatic output of a signal includes the output of an acoustic signal. In this context, the output of an acoustic signal may be affected by actuating a horn of the vehicle. With this variation, it is advantageously also possible to warn road users who do not have any receiving equipment for receiving warning signals.

Moreover, the automatic output of a signal may additionally or alternatively include the output of a visual signal. In one embodiment, the visual signal is output by actuation of a light signalling device of the vehicle, for example by actuation of at least one headlight of the vehicle. In this way too, it is possible to warn road users that do not have a receiving device.

The application also relates to a method for operating a driver assistance system of motor vehicle, wherein the driver assistance system includes a collision warning system and wherein the method comprises the following steps. A determination is made as to whether at least one other road user is located in the range of a current immediate vicinity of the motor vehicle. If it is determined that at least one other road user is located in the range of a current immediate vicinity of the motor vehicle, a priority condition of the motor vehicle with respect to the at least one other road user is assessed. A determination is also made as to whether a violation of the determined priority condition by taking place. If it is determined that the at least one other road user is in violation of the determined priority condition, a signal is output automatically to the at least one other road user for automatic actuation of at least one element selected from a braking device, an propulsion mechanism, a steering device and a warning device of the other road user.

The method according to this embodiment again enables further improved avoidance of traffic accidents. This is assured by the determination as to whether the at least one other road user is in violation of the determined priority condition and by the automatic output of a signal for automatic actuation of at least one of the listed elements of the other road user. In this context, the reasoning is based on the premise that when a violation of the priority condition is already in progress the other road user should be informed thereof as immediately as possible, so that a possible collision with the vehicle can be avoided. In such case, not only may the warning device be actuated automatically in order to alert the other road user to the situation, but an automatic intervention may also be made in the other road user's driving dynamics by means of automatic actuation of the other road user's braking, propulsion and/or steering mechanism. In such case, the automatic actuation of the propulsion mechanism may particularly include deactivation of the propulsion mechanism.

The priority condition of the vehicle is determined by means of data collected by at least one sensor on the vehicle, wherein the at least one sensor is selected from a radar sensor, a lidar sensor, an ultrasonic sensor and an optical camera. Corresponding data for determining the priority condition may be provided by the sensors listed, which are also referred to as environment sensors, wherein the number of components required for the method may also be reduced advantageously due to the increased use of such environment sensors in motor vehicles.

Moreover, the vehicle's priority condition may also be determined additionally or alternatively by means of map data kept on a storage device. The storage device may be a component of a navigation system of the vehicle. For example, the map data may include information regarding the rights of way of individual roads relative to each other, which may serve as the basis for drawing conclusions about the priority condition of the vehicle travelling on a corresponding road or street.

The priority condition may also be determined additionally or alternatively with the aid of data that is received from a vehicle-to-vehicle communication device and/or a vehicle-to-infrastructure communication device on board the vehicle. In this way, it is possible to assess in particular traffic situations in which the other road user is not or not yet captured via the environment sensors, for example in an intersection area in which the other road user may be concealed by other objects.

In a further embodiment, a determination is also made as to whether a violation of the calculated priority condition by the at least one other road user represents a situation of increased danger. In this embodiment a signal is automatically output to the at least one other road user if a violation of the calculated priority condition by the at least one other road user represents a situation of increased danger. In this way, it may be advantageously ensured that the other road user is not alerted constantly to the existence of other road users with higher priority in terms of right of way, to the point that an alert to a real hazard is no longer noticed.

The application also relates to a driver assistance system for a motor vehicle, wherein the driver assistance system includes a collision warning system. The driver assistance system includes a first determination device that is designed to determine whether at least one other road user is located in the range of a current immediate vicinity of the vehicle. The driver assistance system is also equipped with a second determination device that is designed to determine a priority condition of the vehicle with respect to the at least one other road user if it is determined that at least one other road user is located in the range of a current immediate vicinity of the vehicle. The driver assistance system is also equipped with a third determination device that is designed to determine whether the at least one other road user is likely to violate the assessed priority condition. The driver assistance system is also equipped with an output device that is designed to output a signal to the at least one other road user automatically if it is determined that a possible violation of the determined priority condition by the at least one other road user is imminent.

The application further relates to a driver assistance system for a motor vehicle, wherein the driver assistance system includes a collision warning system. The driver assistance system includes a first determination device that is designed to determine whether at least one other road user is located in the range of a current immediate vicinity of the vehicle. The driver assistance system is further equipped with a second determination device that is designed to determine a priority condition of the vehicle with respect to the at least one other road user if it is determined that at least one other road user is located in the range of a current immediate vicinity of the vehicle. The driver assistance system is also equipped with a third determination device that is designed to determine whether the at least one other road user is violating the assessed priority condition. The driver assistance system is also equipped with an output device that is designed to output a signal to the at least one other road user automatically for automatic actuation of at least one element selected from a braking device, a propulsion mechanism, a steering device and a warning device of the other road user if it is determined that the at least one other road user is violating the determined priority condition.

The driver assistance systems according to the application have the advantages that have already been described in the context of the respective methods according to the application, and these will not be listed here again to avoid repetitions.

The application further relates to a computer software product that, when executed on a calculator unit of a driver assistance system wherein the driver assistance system includes a collision warning system, instructs the calculator unit to carry out the following steps. The calculator unit is instructed to determine whether at least one other road user is located in the in the range of a current immediate vicinity of the vehicle. If it is determined that at least one other road user is located in the range of a current immediate vicinity of the vehicle, the calculator unit is instructed to determine a priority condition of the vehicle with respect to the at least one other road user. The calculator unit is also instructed to determine whether a possible violation of the determined priority condition by the at least one other road user is imminent. If it is determined that a possible violation of the assessed priority condition by the at least one other road user is imminent, the calculator unit is instructed to automatically output a signal to the at least one other road user.

The application also relates to a computer software product that, when executed on a calculator unit of a driver assistance system wherein the driver assistance system includes a collision warning system, instructs the calculator unit to carry out the following steps. The calculator unit is instructed to determine whether at least one other road user is located in the in the range of a current immediate vicinity of the vehicle. If it is determined that at least one other road user is located in the range of a current immediate vicinity of the vehicle, the calculator unit is instructed to determine a priority condition of the vehicle with respect to the at least one other road user. The calculator unit is also instructed to determine whether the at least one other road user is violating the assessed priority condition. If it is determined that the at least one other road user is violating the assessed priority condition, the calculator unit is also instructed to output a signal to the at least one other road user automatically for automatic actuation of at least one element selected from a braking device, a propulsion mechanism, a steering device and a warning device of the other road user.

The application also relates to computer-readable medium on which is stored a computer software product according to at least one of the embodiments described.

The computer software products and the computer-readable medium according to the application have the advantages that have already been described in the context of the respective methods according to the application, and these will not be listed here again to avoid repetitions.

### BRIEF DESCRIPTION OF THE FIGURES

The present disclosure will hereinafter be described in conjunction with the following drawing figures, wherein like numerals denote like elements, and:

FIG. 1 shows a flowchart of a method for operating a driver assistance system of a motor vehicle according to a first embodiment of the application;

FIG. 2 shows a flowchart of a method for operating a driver assistance system of a motor vehicle according to a second embodiment of the application;

FIG. 3 shows a flowchart of a method for operating a driver assistance system of a motor vehicle according to a third embodiment of the application;

FIG. 4 shows a flowchart of a method for operating a driver assistance system of a motor vehicle according to a fourth embodiment of the application;

FIGS. 5A to 5C show examples of traffic situations in which the method according to the application may be used;

FIGS. 6A to 6C show further examples of traffic situations in which the method according to the application may be used;

FIG. 7 shows a driver assistance system of a motor vehicle according to a first embodiment of the application; and

FIG. 8 shows a driver assistance system of a motor vehicle according to a second embodiment of the application.

### DETAILED DESCRIPTION

The following detailed description is merely exemplary in nature and is not intended to limit the disclosure or the application and uses. Furthermore, there is no intention to be bound by any theory presented in the preceding background or the following detailed description

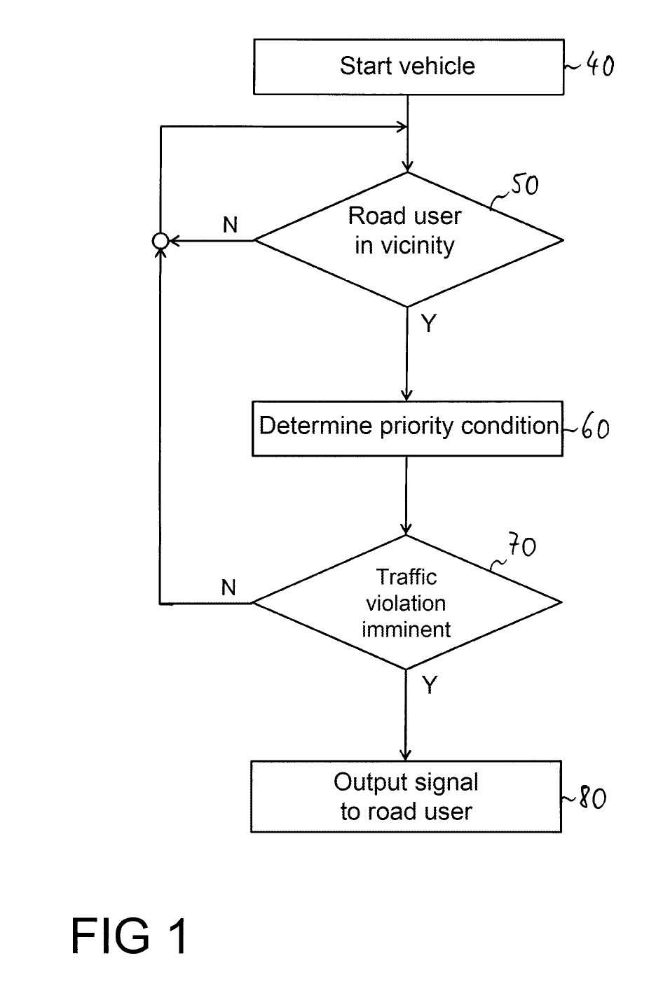

FIG. 1 shows a flowchart of a method for operating a driver assistance system of a motor vehicle according to a first embodiment of the application. The driver assistance system includes a collision warning system and the vehicle is for example a motor car.

The vehicle is started in a step 40, and in the embodiment shown at least one sensor of the vehicle that is designed to detect objects within a detection range is also activated. In this context, the at least one sensor is a radar sensor, a lidar sensor, an ultrasonic sensor or an optical camera. In a further embodiment, the at least one sensor is activated when the speed of the vehicle exceeds a predetermined minimum limit.

In a step 50 a determination is made on the basis of the data collected by the at least one sensor as to whether at least one other road user is located in the range of a current immediate vicinity of the vehicle.

If no other road user is located in the range of a current immediate vicinity of the vehicle, this being within the detection range of the sensor in the embodiment shown step 50 is performed again.

On the other hand, if it is determined that at least one other road user is located in the range of a current immediate vicinity of the vehicle, in step 60 a determination of the priority condition of the vehicle with respect to the at least one other road user is carried out.

In this context, the priority condition may be determined using the data collected by the at least one sensor of the vehicle. For example, if the sensor is in the form of an optical camera, lane markings and/or traffic signs may be detected via image analysis, thus enabling a conclusion to be reached regarding the priority condition. Objects detected additionally by the sensor, in the form of a roundabout for example, may also serve as the basis for determining the priority condition.

The priority condition of the vehicle may additionally or alternatively be determined by means of map data held in a storage device, wherein the storage device is a component of the vehicle's navigation system.

The priority condition may also be carried out on the basis of data received from a vehicle-to-vehicle communication device and/or a vehicle-to-infrastructure communication device on board the vehicle. For example, this may be used to make an assessment of a traffic situation in which a pedestrian is crossing the road at a pedestrian crossing but while the crossing light is red. In this case, the capability of environment sensor systems to determine the status of the pedestrian crossing light is only limited, so that direct transmission of the status of the lights to the vehicle via a vehicle-to-vehicle communication device is advantageous.

In a step 70, a determination is made as to whether a possible violation of the determined priority condition by the at least one other road user is imminent.

If it is determined that no such violation of traffic regulations is imminent, steps 50 and possibly 60 and 70 as well are carried out again.

On the other hand, if it is determined in step 70 that a possible violation of the priority condition by the at least one other road user is imminent, in a step 80 a signal is automatically output to the least one other road user.

The automatic output may include transmission of the signal via a vehicle-to-vehicle communication device. The automatic output of the signal may include the automatic output of an acoustic signal, for example by actuating a horn on the vehicle, and/or a visual signal, for example by actuating at least one light signal device of the vehicle.

In addition, in step 80 a warning signal may also be output in the vehicle, for example via an acoustic and/or visual warning device. In this way, the occupants of the vehicle, particularly the driver of the vehicle, may be alerted to the current traffic situation.

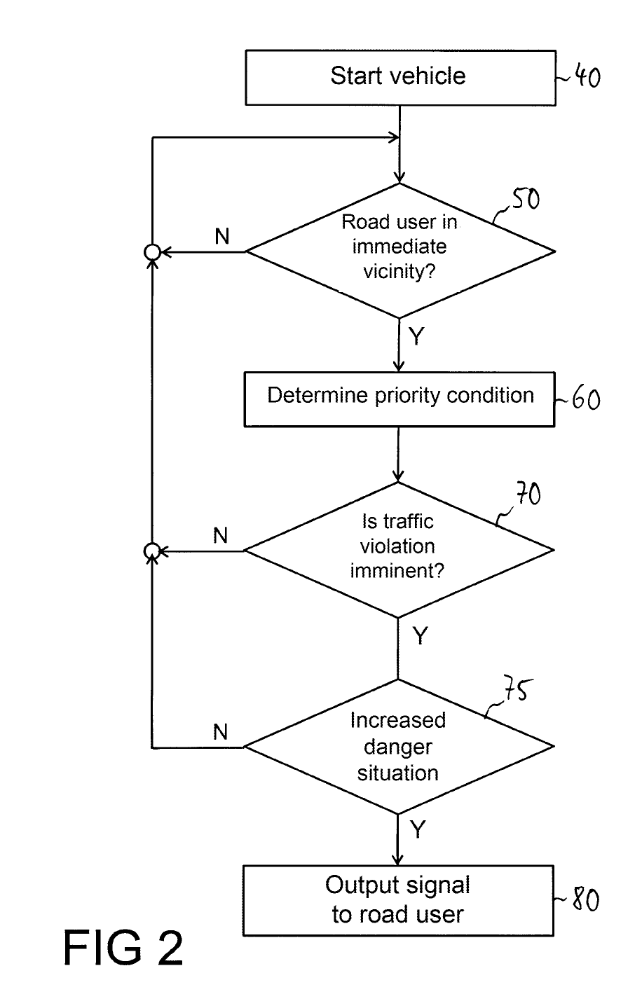

FIG. 2 shows a flowchart of a method for operating a driver assistance system of a motor vehicle according to a second embodiment of the application. The driver assistance system again includes a collision warning system and the vehicle is for example a motor car.

The vehicle is started in a step 40, and similarly to step 40 of the first embodiment shown in FIG. 1 at least one sensor of the vehicle is activated at the same time.

In a step 50, also in the same way as in step 50 of the first embodiment shown in FIG. 1, a determination is made as to whether at least one other road user is located in the range of a current immediate vicinity of the vehicle.

If no other road user is located in the range of the current immediate vicinity of the vehicle, step 50 is performed again.

On the other hand, if it is determined that at least one other road user is located in the range of a current immediate vicinity of the vehicle, in a step 60 a determination of the priority condition of the vehicle with respect to the at least one other road user is carried out in the same way as in step 60 of the first embodiment shown in FIG. 1.

In a step 70, a determination is made as to whether a possible violation of the determined priority condition by the at least one other road user is imminent.

If a possible violation of the priority condition is not imminent, steps 50 and possibly 60 and 70 as well are carried out again.

On the other hand, if it is determined that a possible violation of the determined priority condition by the at least one other road user is imminent, in a step 75 of the second embodiment shown in FIG. 2 a determination is made as to whether the imminent violation of the priority condition represents a situation of increased danger or will lead to a situation of increased danger.

If it is determined that the imminent violation of traffic regulations will not lead to a situation of increased danger or does not represent a situation of increased danger, steps 50 and possibly 60, 70 and 75 as well are carried out again.

On the other hand, if it is determined in step 75 that the imminent violation of the assessed priority condition does represent a situation of increased danger, in a step 80 a signal is automatically output to the at least one other road user, in similar manner to step 80 in the first embodiment as shown in FIG. 1.

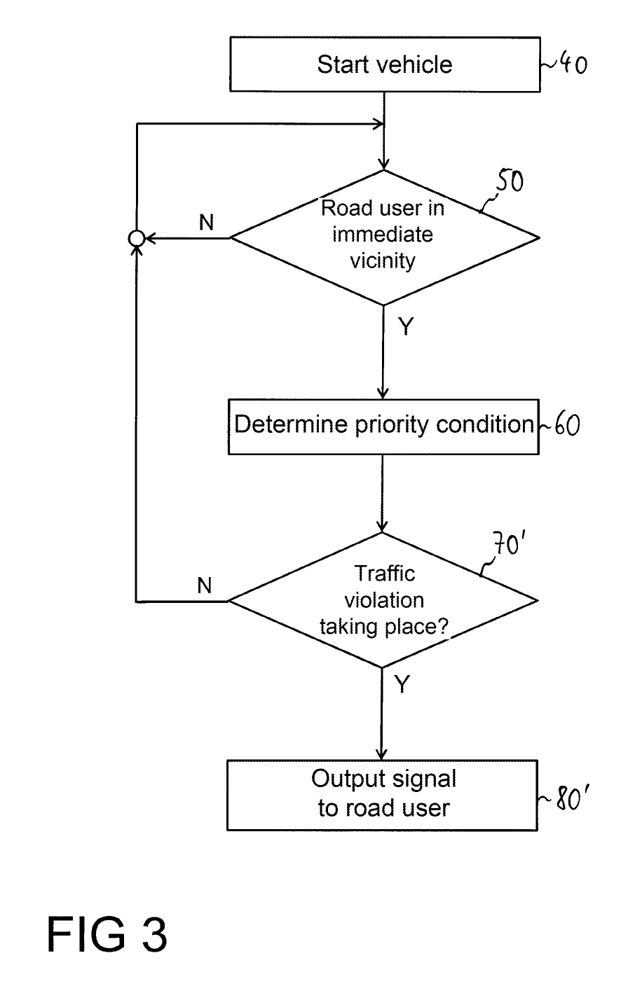

FIG. 3 shows a flowchart of a method for operating a driver assistance system of a motor vehicle according to a third embodiment of the application. The driver assistance system includes a collision warning system and the vehicle is for example a motor car.

The vehicle is started in a step 40, and similarly to step 40 of the first embodiment as shown in FIG. 1 at least one sensor of the vehicle is activated at the same time.

In a step 50, a determination is made as to whether at least one other road user is located in the range of a current immediate vicinity of the vehicle on the basis of data collected by the at least one sensor. This is carried out in the same way as in step 50 of the first embodiment shown in FIG. 1.

If no other road user is located in the range of the current immediate vicinity of the vehicle, step 50 is performed again.

On the other hand, if it is determined in step 50 that at least one other road user is located in the range of a current immediate vicinity of the vehicle, in a step 60 a determination of the priority condition of the vehicle with respect to the at least one other road user is carried out. This determination of the priority condition is carried out in the same way as in step 60 of the first embodiment shown in FIG. 1.

In a step 70′, a determination is made in the third embodiment as to whether the at least one other road user is violating the assessed priority condition.

If it is determined in this step that there is no violation of the priority condition, steps 50 and possibly 60 and 70′ as well are carried out again.

On the other hand, if it is determined in step 70′ that the at least one other road user is violating the assessed priority condition, in a step 80′ a signal is automatically output to the at least one other road user, wherein the signal comprises control signals for automatic actuation of at least one element selected from a braking device, a propulsion mechanism, a steering device and a warning device of the other road user.

In step 80′ a warning signal may also be output in the vehicle and/or an automatic intervention in the driving dynamics of the vehicle may be carried out.

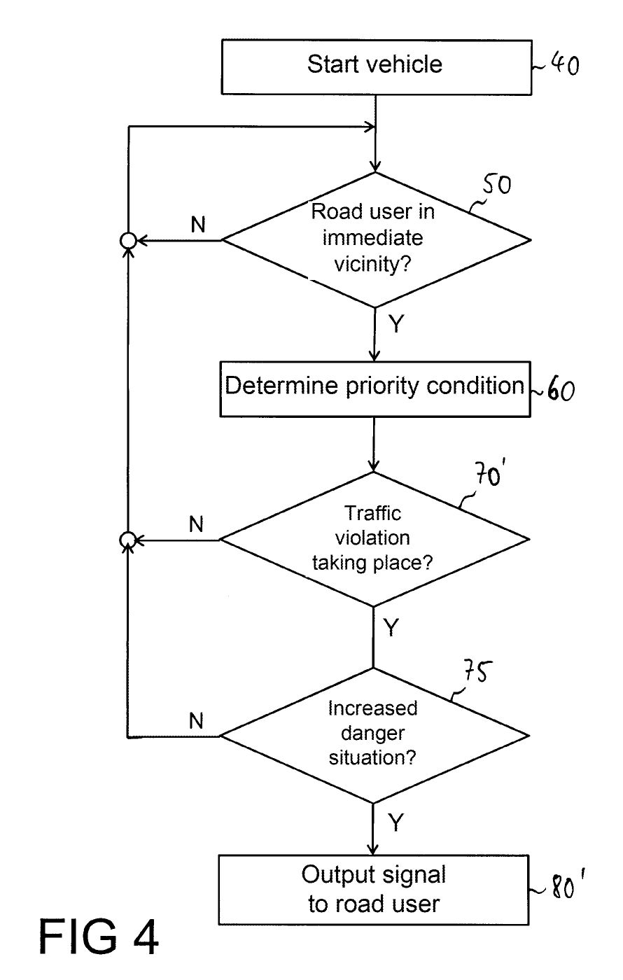

FIG. 4 shows a flowchart of a method for operating a driver assistance system of a motor vehicle according to a fourth embodiment of the application. The driver assistance system again includes a collision warning system and the vehicle is for example a motor car.

The vehicle is started in a step 40, and similarly to step 40 of the first embodiment as shown in FIG. 1 at least one sensor of the vehicle is activated.

In a step 50, a determination is made as to whether at least one other road user is located in the range of a current immediate vicinity of the vehicle in the same way as in step 50 of the first embodiment shown in FIG. 1.

If no road user is located in the range of the current immediate vicinity of the vehicle, step 50 is performed again.

On the other hand, at least one other road user is located in the range of a current immediate vicinity of the vehicle, in a step 60 a determination of a priority condition of the vehicle with respect to the at least one other road user is carried out in the same way as in step 60 of the first embodiment shown in FIG. 1.

In a step 70′, a determination is made as to whether the at least one other road user is violating the assessed priority condition.

If it is determined in this step that there is no violation, steps 50 and possibly 60 and 70′ as well are carried out again.

On the other hand, if it is determined in step 70′ that a violation of the assessed priority condition exists, in a step 75 in the embodiment represented in FIG. 4 a determination is made as to whether the violation of the priority condition represents a situation of increased danger.

If it is determined in this step that the violation of the priority condition does not represent a situation of increased danger, steps 50 and possibly 60, 70′ and 75 as well are carried out again.

On the other hand, if it is determined in step 75 that the violation will lead to a situation of increased danger or that the violation represents a situation of increased danger, in a step 80′ a signal is automatically output to the at least one other road user, in similar manner to step 80′ in the embodiment as shown in FIG. 3.

The embodiments described may thus be used to influence other road users and thereby prevent improper driving conduct or lower the probability thereof. At the same time, environment sensors may be used by a first road user in the form of the vehicle for the purpose of assessing whether a potential danger of failure to comply with priority regulations by another, additional road user exists. In one variation of the method, depending on the nature of the potential danger a message is transmitted from the first road user to the other road user, for example via a WLAN interface. Light signals such as a headlamp flasher, acoustic signals such as the vehicle horn or oscillation signals such as a low-frequency vibration signal may also be triggered directly by the first road user, that is to say the motor vehicle, in order to gain the attention of the other road user via the human senses.

At a first level, a notification may be passed from the motor vehicle to the other road user regarding the potential threat to safety before a violation of traffic regulations has actually taken place. In this context, for example a display in the other vehicle is possible with the notification: “Caution, be aware of approaching vehicle, vehicle in blind spot, yield to vehicle from left” and similar. It is also possible for the vehicle to trigger a very brief actuation of the horn, by which the attention of the other road user may be directed to the traffic situation. This is particularly advantageous if the other road user does not possess a receiver for the transmission of the notification.

At a second level, if it is already evident that the conduct of the other vehicle is tending to increase the danger level of a situation, a warning signal may be emitted by the first vehicle, for example. This is the case for example if the other road user begins to cross the lane markings and attempts to move into the lane occupied by the vehicle. This might also be the case if the other road user is turning into a road with right of way just as the vehicle is approaching on it. In this case the warning may take the form of triggering an acoustic signal in the vehicle of the other road user for example.

At a third level, the motor vehicle is able to initiate active system interventions on the other road user. These may be active steering actions to bring the other road user back into his original lane. However, active braking actions may also be initiated in order to prevent the vehicle from entering an intersection in a manner that violates traffic regulations.

With the embodiments shown, it thus becomes possible to prevent accidents in advance either by issuing actively triggered notifications of possible dangers or actively warning the other road user when conduct in violation of the traffic regulations is detected.

In this context, it is first determined which priority condition currently exists. Besides environment sensors, digital maps and road sign detection information may also be used for this. In some embodiments, it is provided that information is not transmitted to the other road user unless an action in violation of traffic regulations is imminent and the action is also likely to pose a threat to safety. In this way, it is ensured that the other road users are not alerted constantly to the existence of other road users with right of way, to the point that an alert to an actual hazard is no longer noticed. Further details will be explained in greater detail in conjunction with the following FIGS.

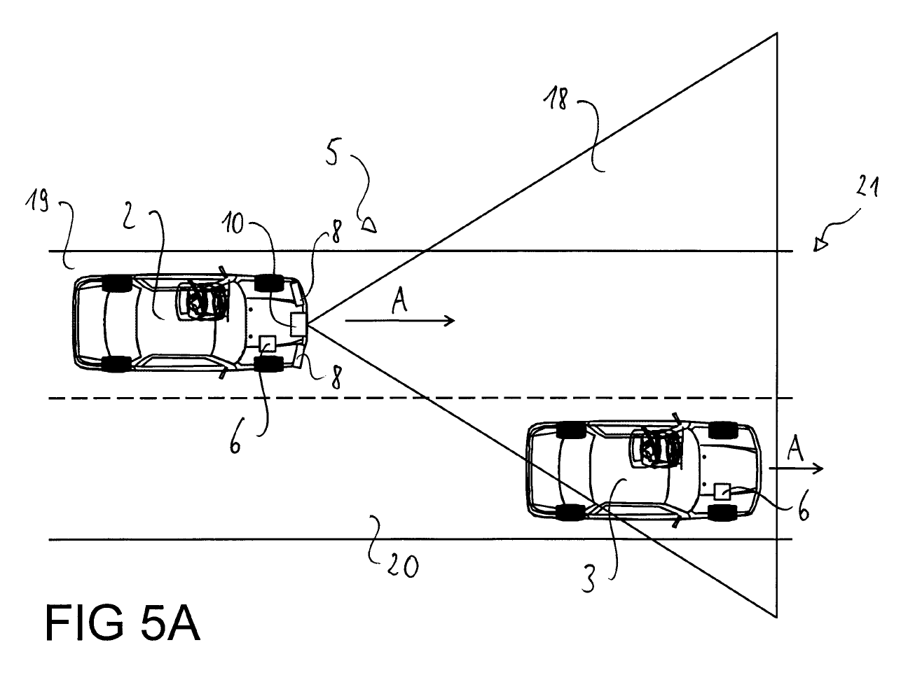

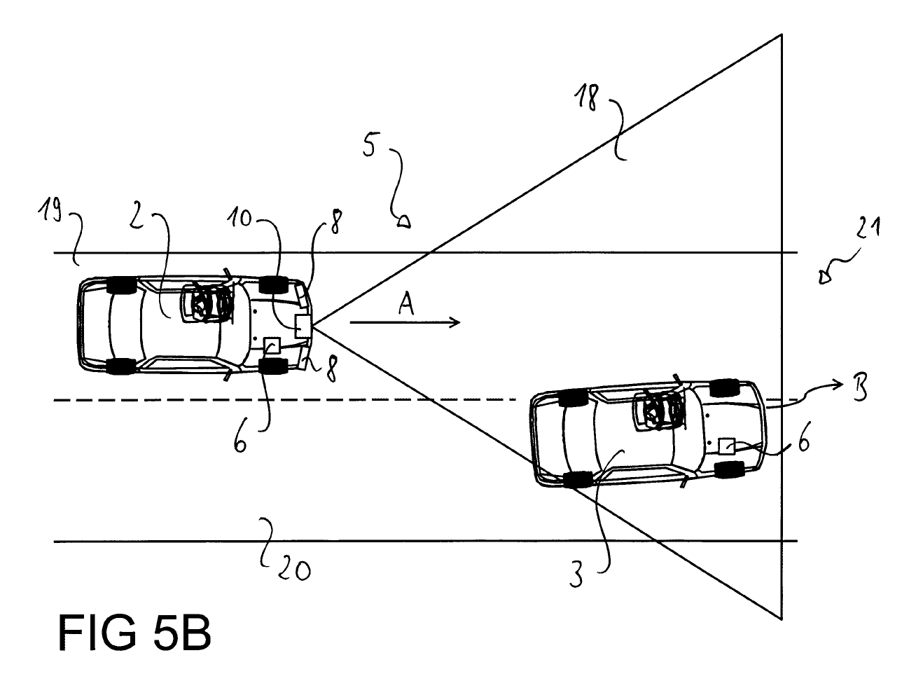

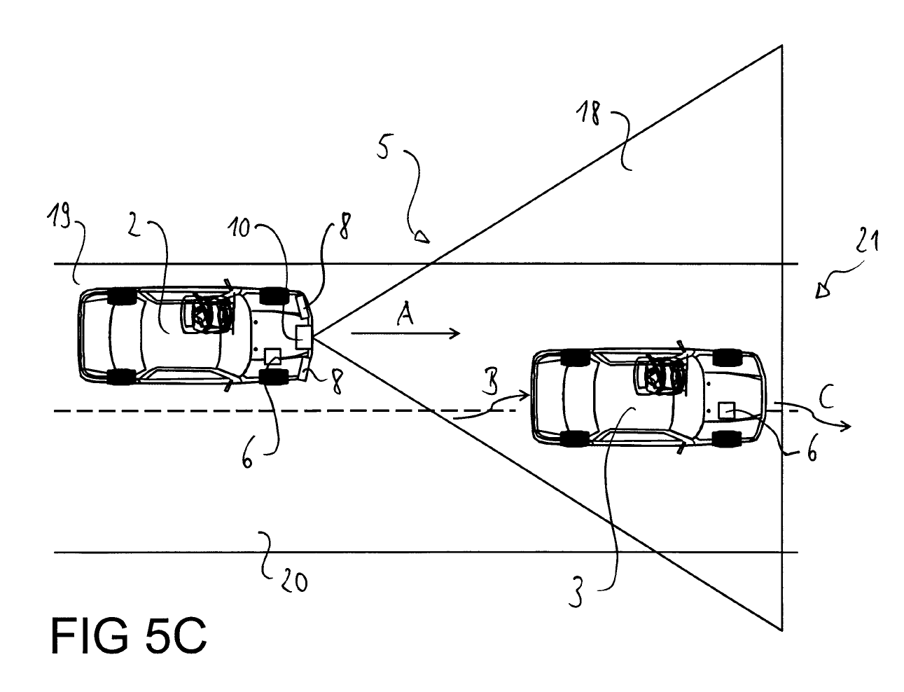

For this purpose, FIGS. 5A to 5C show examples of traffic situations in which the methods according to the embodiments of the application, particularly the methods according to the embodiments shown in FIGS. 1 to 4, may be used. Components having the same functions are identified with the same reference numerals.

In the traffic situation shown in FIG. 5A, a motor vehicle 2, a passenger car in the situation shown, is travelling in direction indicated diagrammatically by an arrow A in a first lane 19 of a carriageway 21. Besides lane 19, carriageway 21 also has another lane 20 for vehicles travelling in the same direction. Carriageway 21 is for example a part of a motorway or a major trunk road.

In the traffic situation shown, another road user 3, in the form of another passenger car, is travelling in lane 20 in the same direction as vehicle 2 at a speed that is lower than the speed of vehicle 2. For example, vehicle 2 is travelling at 140 km/h, whereas road user 3 is only travelling at 80 km/h. However, the other road user 3 is in front of vehicle 2 in the direction of travel, and vehicle 2 begins to undertake an overtaking manoeuvre of the other road user 3.

In this situation, vehicle 2 is equipped with at least one sensor 10, which is selected from a radar sensor, a lidar sensor, an ultrasonic sensor and an optical camera. Sensor 10 is designed to detect objects within a diagrammatically represented detection range 18. The other road user 3 is located at least partly within detection range 18, so that it is evident on the basis of the data collected by sensor 10 that road user 3 is in the range of a current immediate vicinity 5 of vehicle 2. Vehicle 2 is also equipped with two light signal devices 8 in the form of right and left front headlamps.

As will be explained in greater detail with reference to the subsequent FIGS., in this context a determination of a priority condition of vehicle 2 with respect to road user 3 is carried out, as well as an assessment of the likelihood that the other road user 3 will violate the determined priority condition. If it is determined that a possible violation of the determined priority condition by the other road user 3 is imminent, a signal is automatically output to the other road user 3.

The signal may be transmitted via a vehicle-to-vehicle communication device 6 of vehicle 2 to the other road user 3, which is also equipped with a vehicle-to-vehicle communication device 6, and may include for example the notification “Vehicle approaching”.

In the traffic situation shown in FIG. 5B, vehicle 2 is again travelling in first lane 19 of carriageway 21. The other road user 3 begins a lane change maneuver from the second lane 20 to lane 19, as is shown diagrammatically by an arrow B. At this point, the other road user 3 is already partially in lane 19. In the traffic situation shown, a signal may be sent automatically to the other road user 3, for example the transmission of a signal via vehicle-to-vehicle communication device 6 for sending a warning signal, for example in the form of an audible warning signal via a warning device (not further illustrated) of the other road user 3. In addition, a warning signal in the form of a headlamp flasher may be emitted by actuation of at least one of the light signal devices 8 of vehicle 2 and/or in the form of an acoustic signal by actuation of a horn on vehicle 2 (not further illustrated).

In the traffic situation represented in FIG. 5C, vehicle 2 is again travelling in lane 19 of carriageway 21. The other road user 3 has begun a lane changing maneuver from the other lane 20 to lane 19, as is shown diagrammatically with an arrow B, and in the traffic situation shown is already positioned mostly in lane 19. In the situation shown, therefore, an automatic signal may be transmitted to the other road user 3 via vehicle-to-vehicle communication device 6 for active intervention into the driving dynamics of the other road user 3, for example to enable active steering intervention by means of automatic actuation of a steering device (not further shown) of the other road user 3. In this way, the other road user 3 may be steered back into its original lane 20, as is shown diagrammatically with an arrow C. In addition, a braking device and/or a propulsion mechanism of the other road user 3 may also be actuated automatically.

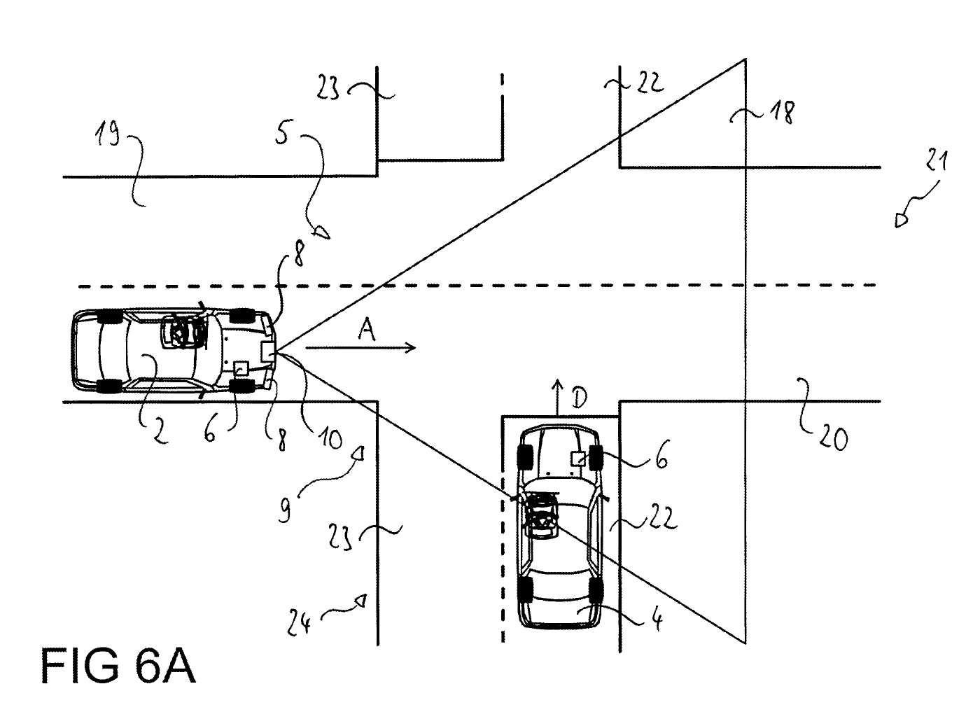

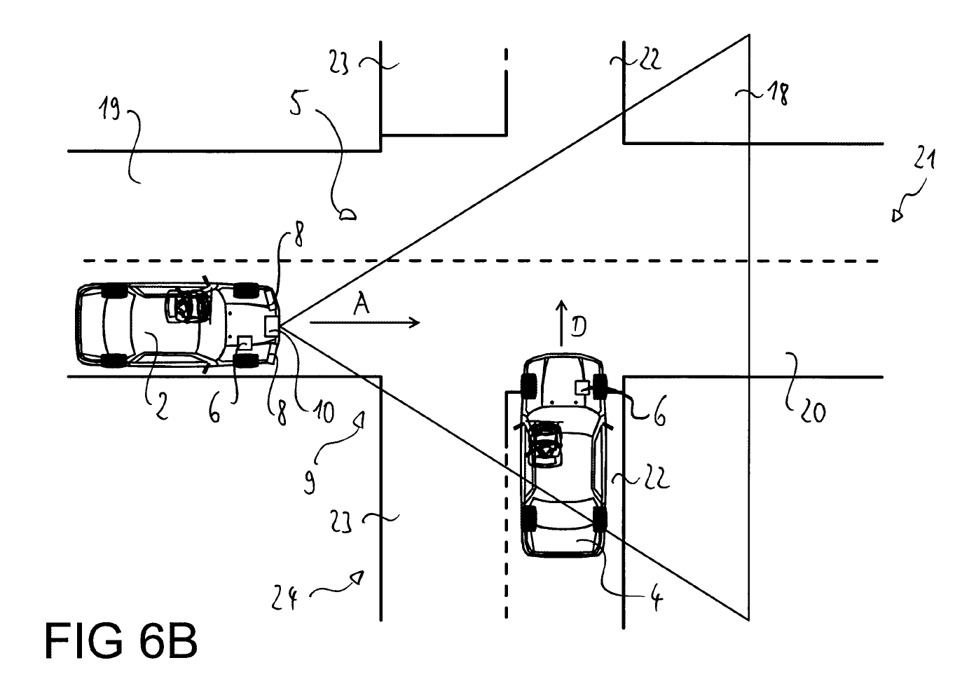

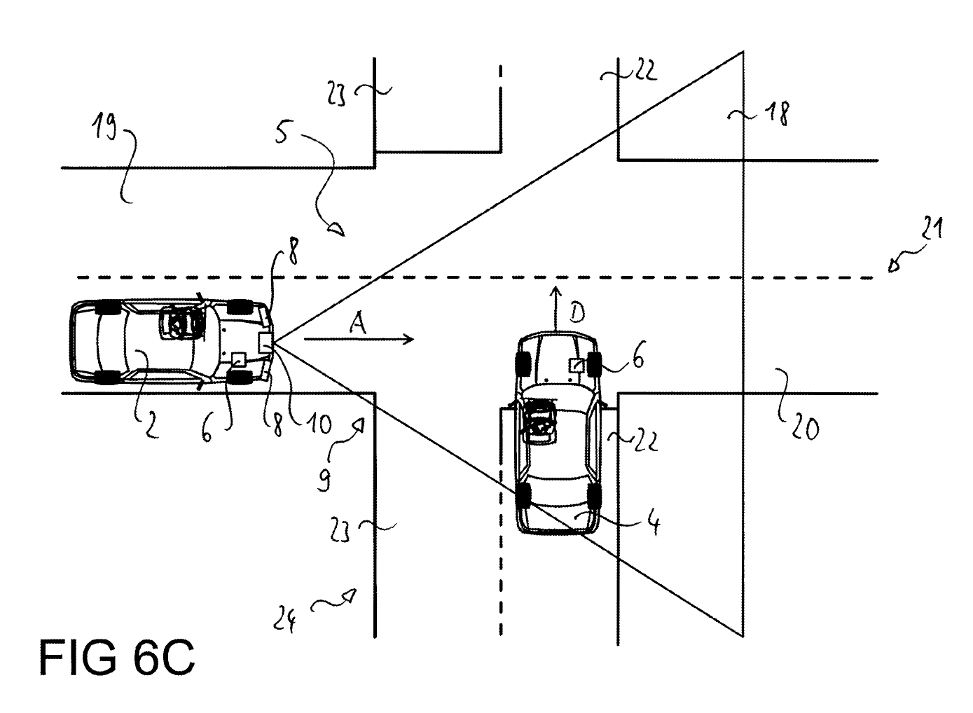

FIGS. 6A to 6C show further examples of traffic situations in which the methods according to the embodiments of the application, particularly according to the embodiments illustrated in FIGS. 1 to 4 may be used. Components with the same functions as in the previous FIGS. are identified with the same reference numerals and will not be described again in the following.

In the traffic situation shown in FIG. 6A, vehicle 2 is travelling in lane 20 of carriageway 21 in a direction represented diagrammatically by an arrow A and is approaching an intersection 9, at which another carriageway 24 joins carriageway 21. Carriageway 24 has two lanes 22 and 23. Another road user 4, a passenger car, is travelling in lane 24 in a direction indicated diagrammatically with an arrow D and is approaching intersection 9. The other road user 4 is again positioned at least partly within detection range 18 of sensor 10. In the traffic situation shown, a determination is therefore made of a priority condition of vehicle 2 with respect to the other road user 4, and a determination is also made as to whether a violation of the assessed priority condition by the other road user 4 is imminent.

In this context, a signal is automatically output to the other road 4, if it is determined that a possible violation of the assessed priority condition is imminent. For example, a message with a notification “Yield to vehicle approaching from left” may be transmitted to the other road user 4 via vehicle-to-vehicle communication device 6 of vehicle 2. In addition, a warning signal in the form of brief actuation of a horn of vehicle 2 (not further shown in FIG. 6B) may be output to the other road user 4.

In the traffic situation shown in FIG. 6B, vehicle 2 is again travelling in lane 20 of carriageway 21. The other road user 4 is entering intersection 9 and is already located partly in lane 20. In the situation shown, a warning signal in the form of an acoustic signal may be emitted for example by a warning device of the other road user 4 (not further shown). This is performed by transmitting a signal from vehicle 2 to the other road user 4. Also, a warning signal in the form of flashing headlamps may additionally or alternatively be initiated by actuation of at least one of the light signal devices 8 of vehicle 2 or in the form of a long horn blast by actuation of a horn on vehicle 2.

In the traffic situation shown in 6C, vehicle 2 is again travelling in lane 20 of carriageway 21. The other road user 4 is entering intersection 9 from lane 22 of carriageway 24 and is substantially in lane 20. In the situation shown, an active braking intervention may be applied for example by automatic transmission to the other road user 4 of a corresponding signal with control signals via vehicle-to-vehicle communication device 6.

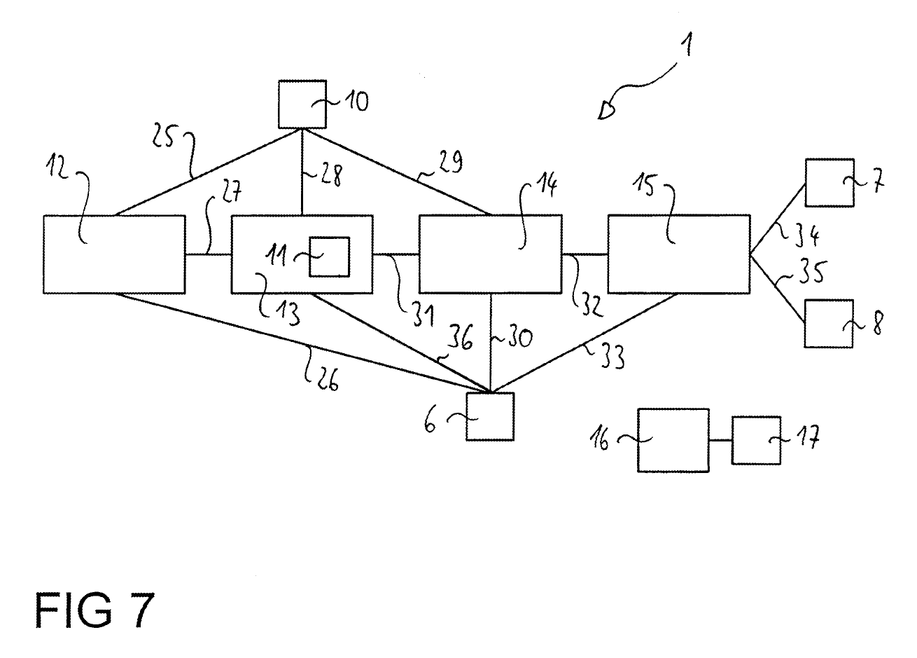

FIG. 7 shows a driver assistance system 1 of a vehicle (not further illustrated in FIG. 7) according to an embodiment of the application. Components with the same functions as in the previous figures are identified with the same reference numerals and will not be described again in the following.

Driver assistance system 1 includes a collision warning system and includes a first determination device 12, which is designed to determine whether at least one other road user is located in the range of a current immediate vicinity of the vehicle. For this purpose, in the embodiment shown first determination device 12 is connected to sensor 10 via a signal wire 25 and to vehicle-to-vehicle communication device 6 via a signal wire 26. In this arrangement, it is possible to deduce the presence of other road users in the range of the current immediate vicinity of the vehicle using data received by sensor 10 and or vehicle-to-vehicle communication device 6.

Driver assistance system 1 is also equipped with a second determination device 13, which is designed to determine a priority condition of the vehicle with respect to the at least one other road user, if it is determined that at least one road user of such kind is located in the range of a current immediate vicinity of the vehicle.

For this purpose, in the embodiment shown second determination device 13 is connected to sensor 10 via a signal wire 28, so that the priority condition may be determined on the basis of data collected by sensor 10.

For this purpose, second determination device 13 is also equipped with a memory device 11 with map data stored therein, with which the priority condition may be determined using map data.

Second determination device 13 is also connected to vehicle-to-vehicle communication device 6 via signal wire 36. In this way, the priority condition may be assessed using the data received by vehicle-to-vehicle communication device 6. The priority condition may also be determined using data received via a vehicle-to-infrastructure communication device (not further shown) on the vehicle, wherein the vehicle-to-infrastructure communication device and vehicle-to-vehicle communication device 6 may form a common communication unit.

Second determination device 13 is also connected to first determination device 12 via a signal wire 27.

Driver assistance system 1 is further equipped with a third determination device 14, which is designed to determine whether a possible violation of the assessed priority condition by the at least one other road user is imminent. For this purpose, in the embodiment shown third determination device 14 is connected to sensor 10 via a signal wire 29 and to vehicle-to-vehicle communication device 6 via a signal wire 30. Third determination device 14 is also connected to second determination device 13 via a signal wire 31.

Driver assistance system 1 also comprises an output device 15 that is designed to transmit a signal automatically to the at least one other road user if it is determined that a possible violation of the assessed priority condition by the at least one other road user is imminent. For this purpose, in the embodiment shown output device 15 is connected to vehicle-to-vehicle communication device 6 via a signal wire 33 and to a horn 7 via a signal wire 34 and to at least one light signal device 8 of the vehicle via a signal wire 35.

In the embodiment shown, driver assistance system 1 is also equipped with a calculator unit 16 and a computer-readable medium 17, wherein a computer software product is stored on computer-readable medium 17, and when it runs on calculator unit 16 the software instructs calculator unit 16 to carry out the steps described in the context of the embodiments of the method according to the application, particularly the steps represented in FIGS. 1 and 2, by means of the elements described in that context. For this purpose, calculator unit 16 is connected to the corresponding elements directly or indirectly in a manner not further shown.

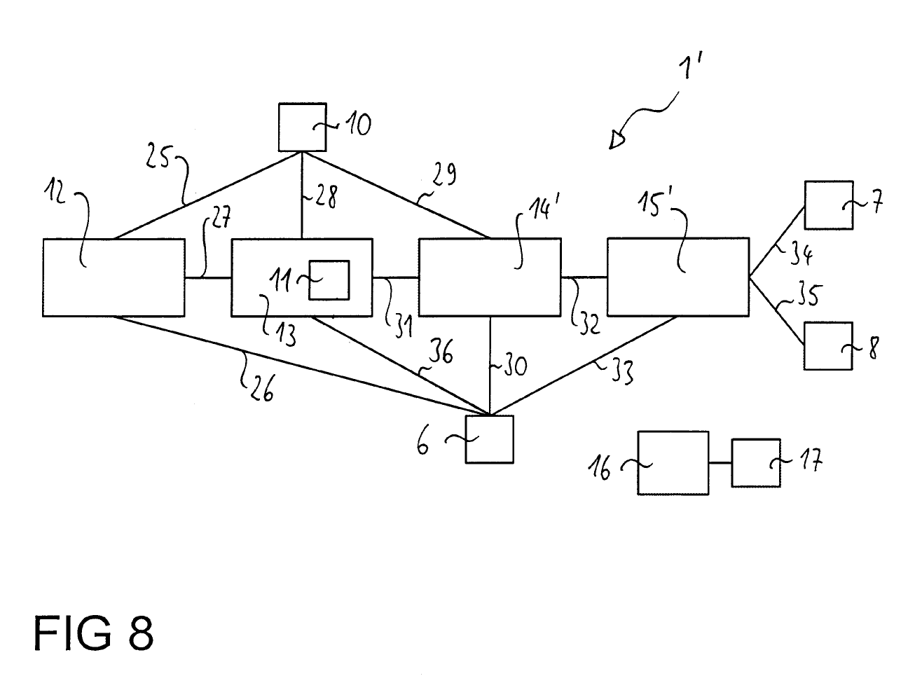

FIG. 8 shows a driver assistance system 1′ of a vehicle (not further illustrated in FIG. 8) according to a second embodiment of the application. Components with the same functions as in the previous FIGS. are identified with the same reference numerals and will not be described again in the following

Driver assistance system 1′ differs from the driver assistance system of FIG. 7 in that a third determination device 14′ of driver assistance system 1′ is designed to determine whether the at least one other road user is in the course of violating an assessed priority condition. An output device 15′ in the illustrated second embodiment for automatically outputting a signal to the at least one other road user with control signals for automatic actuation of at least one element selected from a braking device, a propulsion mechanism, a steering device and a warning device of the other road user if it is determined that the at least one other road user is violating the assessed priority condition. Additionally, an acoustic signal may also be output by actuation of horn 7 and/or an optical signal by actuation of the at least one light signal device 8 of the vehicle.

In the embodiment shown, driver assistance system 1′ is also equipped with a calculator unit 16 and a computer-readable medium 17, wherein a computer software product is stored on computer-readable medium 17, and when it runs on calculator unit 16 the software instructs calculator unit 16 to carry out the steps described in the context of the embodiments of the method according to the application, particularly the steps represented in FIGS. 3 and 4, by means of the elements described in that context. For this purpose, calculator unit 16 is connected to the corresponding elements directly or indirectly in a manner not further shown

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents

What is claimed is:

1. A method for operating a driver assistance system of a motor vehicle, comprising:
making a determination as to whether another road user is located in a range of a current immediate vicinity of the motor vehicle,
if it is determined that at least one other road user is located in the range of the current immediate vicinity of the motor vehicle, determining a priority condition of the motor vehicle with respect to the at least one other road user,
determining whether a possible violation of the assessed priority condition by the at least one other road user is imminent,
if it is determined that at a possible violation of the assessed priority condition by the at least one other road user is imminent, automatically outputting a signal to the at least one other road user.

2. The method according to claim 1, wherein the automatically outputting of the signal includes transmitting the signal via a vehicle-to-vehicle communication device.

3. The method according to claim 1, wherein the automatically outputting of the signal includes emitting an acoustic signal.

4. The method according to claim 3, wherein the acoustic signal actuates a horn of the motor vehicle.

5. The method according to claim 1, wherein the automatically outputting the signal includes emitting an optical signal.

6. The method according to claim 5, wherein the optical signal actuates at least one light signal device of the vehicle.

7. A method for operating a driver assistance system of a motor vehicle, comprising:
making a determination as to whether at least one other road user is located in a range of a current immediate vicinity of the motor vehicle,
if it is determined that at least one other road user is located in the range of the current immediate vicinity of the motor vehicle, determining a priority condition of the motor vehicle with respect to the at least one other road user,
determining whether the at least one other road user is violating the assessed priority condition,
if it is determined that the at least one other road user is violating the assessed priority condition, automatically outputting a signal to the at least one other road user for automatic operation of at least one of a braking device, a propulsion mechanism, a steering device and a warning device of a vehicle of the other road user.

8. The method according to claim 7, wherein the determination of the priority condition of vehicle is made using data captured by at least one sensor of the motor vehicle, wherein the at least one sensor is at least one of a radar sensor, a lidar sensor, an ultrasonic sensor and an optical camera.

9. The method according to any claim 7, wherein the determination of the priority condition of vehicle is made using at least one of map data stored in a memory device, data received via a vehicle-to-vehicle communication device, and a vehicle-to-infrastructure communication of the motor vehicle.

10. The method according to claim 7, wherein it is further determined whether the violation of the assessed priority condition by the at least one other road user represents a situation of increased danger, and wherein a signal is automatically output to the at least one other road user if a violation of the assessed priority condition by the at least one other road user represents a situation of increased danger.

11. A driver assistance system for a vehicle, comprising:
a first determination device that determines whether at least one other road user is located in a range of a current immediate vicinity of the vehicle,
a second determination device that assess a priority condition of the vehicle with respect to the at least one other road user if it is determined that the at least one other road user is located the range of the current immediate vicinity of the vehicle,
a third determination device that determines whether a possible violation of the assessed priority condition is imminent due to the at least one other road user,
an output device that automatically outputs a signal to the at least one other road user if it is determined that a possible violation of the assessed priority condition is imminent due to the at least one other road user.

12. A driver assistance system for a vehicle, comprising:
a first determination device designed to determine whether at least one other road user is located in a range of a current immediate vicinity of the vehicle,
a second determination device designed to assess a priority condition of the vehicle with respect to the at least one other road user if it is determined that at least one other road user is located the range of the current immediate vicinity of the vehicle,
a third determination device designed to determine whether the at least one other road user is violating the assessed priority condition,
an output device designed to automatically output a signal to the at least one other road user for automatic actuation of a least one of a braking device, a propulsion mechanism, a steering device and a warning device of a vehicle of the other road user if it is determined that the at least one other road user is violating the assessed priority condition.

13. A computer software product, that, when executed on a calculator unit of a driver assistance system of a motor vehicle, instructs the calculator unit to carry out the following steps:
determine whether at least one other road user is located in a range of a current immediate vicinity of the motor vehicle,
if it is determined that at least one other road user is located in the range of the current immediate vicinity of the motor vehicle, determine a priority condition of the motor vehicle with respect to the at least one other road user,
determine whether a possible violation of the determined priority condition by the at least one other road user is imminent,
if it is determined that a possible violation of the assessed priority condition by the at least one other road user is imminent, automatically output a signal to the at least one other road user.

14. A computer software product, that, when executed on a calculator unit of a driver assistance system of a motor vehicle, instructs the calculator unit to carry out the following steps:
determine whether at least one other road user is located in a range of a current immediate vicinity of the motor vehicle,
if it is determined that at least one other road user is located in the range of the current immediate vicinity of the motor vehicle, determine a priority condition of the motor vehicle with respect to the at least one other road user,
determine whether the at least one other road user is violating the determined priority condition,
if it is determined that the at least one other road user is violating the assessed priority condition, automatically output a signal to the at least one other road user for the automatic actuation of at least one of a braking device, a propulsion mechanism, a steering device and a warning device of the other road user.
